(19) United States
(12) Patent Application Publication
(10) Pub. No.: US 2020/0131792 A1
(43) Pub. Date: Apr. 30, 2020

(54) Apparatus for Maintaining Pool or Spa Full Level- Staypoollizer

(71) Applicant: James M. Litteral, St Cloud, FL (US)

(72) Inventor: James M. Litteral, St Cloud, FL (US)

(21) Appl. No.: 16/666,343

(22) Filed: Oct. 28, 2019

Related U.S. Application Data
(60) Provisional application No. 62/751,687, filed on Oct. 28, 2018.

(51) Int. Cl. E04H 4/12; F16K 31/18

(52) U.S. Cl. CPC E04H 4/12; F16K 31/18

(57) ABSTRACT

A water control device having all elements designed or modified specifically for the corrosive environments of chlorinated and salted water, to include the supplemental actions of UV radiation and thermal cycling. The device composes a support structure designed to fixture itself at any meeting point of the deck and water retaining wall of a pool or spa. The support structure section that contacts the deck is weighted and encompasses anti-skid material at various contact point. The prior mentioned section also contains attached geometry at back end as to retain stability from side to side rotation and to adapt to different configurations of deck and wall construction. The front of the structure contains a member pointing downwards into the water. This downward pointing member communicates with a sliding component that has attached to it a water control assembly. The water control is based on a mechanical float cut-off action and utilizes a continuous water supply.

### CROSS REFERENCE TO RELATED APPLICATIONS

This non-provisional application filing is a continuation-in-part of a provisional application No. 62/751,687 filed on Oct. 28, 2018, which has a current confirmed status. The inventor hereby claim benefit under Title 35, United States Code, Section 119(e).

### FEDERALLY SPONSORED RESEARCH AND DEVELOPMENT

Not applicable.

### BACKGROUND OF THE INVENTION

### Field of the Invention

The present invention relates to an apparatus for the swimming pool and spa industry. The mechanically actuated device maintains a pre-determined pool water level, whereby when actuated; it replaces the water that is loss due to evaporation, leaks, splash-outs and other water loss events. Low water levels can cause serious damage to pool water recirculating and sanitizing sub-systems. Manual replenishing of loss water is overly inconvenient and requires constant monitoring over what can be long periods to achieve the proper fill level—an overall tedious and aggravating task. The aforementioned device utilizes a water buoyant means, nozzle, and seal design to add water when the pool water level drops, and cuts off when the required water level is achieved. This economical and simple method utilized in a properly engineered application specific device will prove to be the winning solution over other market competitive products in the growing pool and spa market.

### Prior Art

In the water containment world such as ponds, pools, animal watering tanks and the likes, there exist devices to automate the process of replenishing water loss. Automated methods of maintaining water level originated from a variety of known and proven practices. For the present invention and the likes, it is a water control apparatus connected to an always-active water supply that is by some means supported above the liquid reservoir in contact with water level and is mechanically driven by the changing water level. The water control apparatus method is a float cut-off action that is basically, an active water flow being blocked and unblocked by a sealing surface in communication with the water buoyant component. The mechanics of this method has been time proven; however, this built-on method will require application specific modifications to be effective for the pool and spa industry as needed. The most popular mechanical “built-on” water control device originates for the farming and livestock sector and used to control and supply fresh and well water to farm animals and wildlife. Therefore, direct integration of this control device will not survive the chemical laden environments of the pool and spa industry and will require extensive modifications predominantly in materials followed by operational design. Therefore, the present invention encompasses comprehensive improvements on the aforementioned and from real founded solutions based on the shortcomings encountered in the installation, testing, and use of the devices reciting prior arts.

### References Cited

U.S. Patent Documents

| | | |
|---|---|---|
| 3,270,770 | November 1966 | Wilson |
| 3,739,405 | June 1973 | Schmidt |
| 3,908,206 | August 1974 | Grewings |
| 4,138,967 | February 1979 | Tamborrino |
| 4,574,405 | April 1984 | Tams |
| 4,586,532 | July 1985 | Tsolkas |
| 4,655,243 | November 1985 | Keller |
| 4,853,986 | August 1989 | Allen |
| 5,203,038 | April 1993 | Gibbs |
| 5,836,022 | November 1998 | Busenga |
| D596,268S | July 2009 | Stetson |
| 8,910,323 | December 2014 | Goettl |

### SUMMARY OF THE INVENTION

The overall objective of the present invention is to provide an application responsive means of replenishing the water loss in a swimming pool or spa due to natural and unnatural causes. The continued use of prior arts for the water replenishing process without modification prove to be weak and with an end result being a short life cycle product or of one under constant repair and adjustments. The aforementioned “application responsive” refers to addressing the severe environment and results that are produced by chemicals used in the pool and spa industry along with the sun's actions both thermal and radiation wise. Hence, an apparatus can experience a water environment that can be heavily chlorinated or salted leading to pre-mature deterioration and eventually failure, in addition and especially outdoors further deteriorating action is supplemented by the sun's UV radiation. The build-up of residual matter, scaling on component surfaces can cause obstruction between components can cause critical failure. The final proof of this product came from repeated installation and testing the best in application materials and calculated geometry to produce an exceptionally built product. The present invention thus represents a tangible solution for a real problem encountered in the growing pool and spa industry.

The key objective was to make the invention's functionality and performance to be specific to the pool and spa industry.

Another objective was to redesign and replace the components of any OEM sub-device with performance specific components engineered for a heavily chlorinated, salinized, extreme temperature cycling and UV radiation prone environments.

Another objective was to make the device simple and aesthetically pleasing, easy to install, set-up and operate; economical and with a longer product life than other similar devices.

### DESCRIPTION OF DRAWINGS

FIG. 1 is a perspective view of the apparatus mounted at pool edge.

FIG. 2 is a perspective view of the overall apparatus.

FIG. 3 is a perspective view of the apparatus frame assembly.

FIG. 4 is a perspective view of the apparatus float assembly.

FIG. 5 is a front section view of the level control assembly.

FIG. 6a is a section view of the swivel nozzle connector.

FIG. 6b is a perspective view of the swivel nozzle connector.

FIG. 6c is an exploded view of the swivel nozzle connector.

FIG. 7a is a side view of the apparatus mounted on a flat deck.

FIG. 7b is a side view of the apparatus mounted on a raised deck.

FIG. 7c is a side view of the apparatus mounted on a tapered deck.

FIG. 7d is a side view of the apparatus mounted on a rail type deck.

FIG. 8a is a side view of the apparatus adjusted at maximum water level.

FIG. 8b is a side view of the apparatus adjusted at midway water level.

FIG. 8c is a side view of the apparatus adjusted at minimum water level.

FIG. 8c is an overall illustration of the invention.

### DETAILED DESCRIPTION OF THE INVENTION

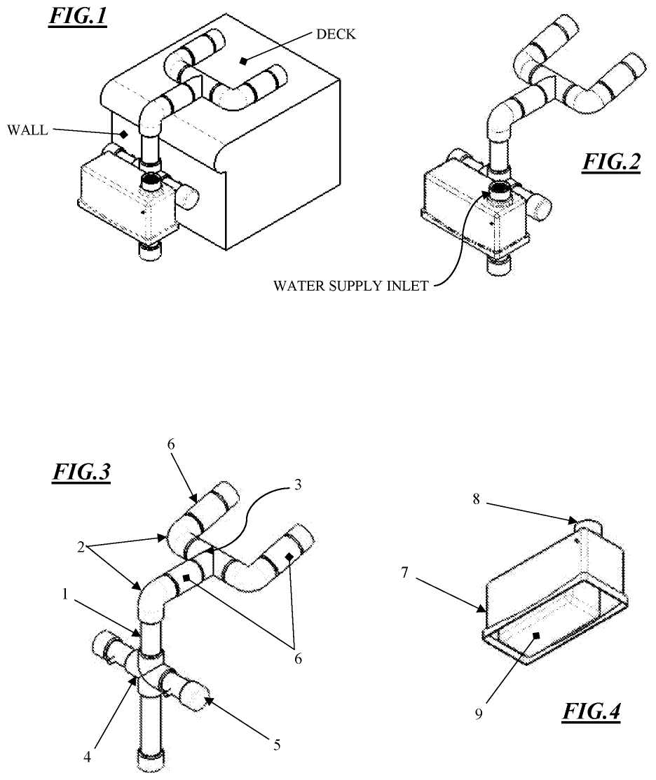

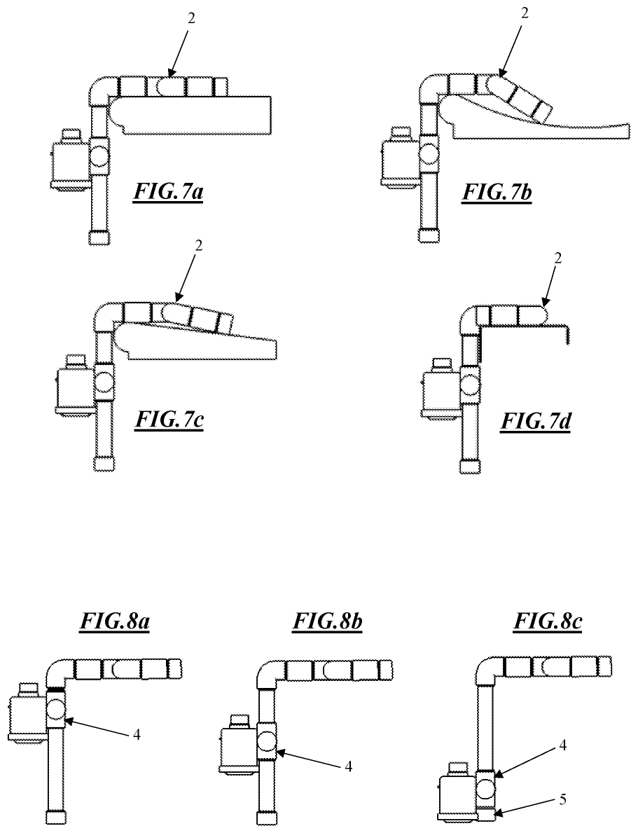

Now with reference to drawings beginning with the complete apparatus FIG. 2. The apparatus is an assembly of an all-tubular structure comprising of hollow plastic tube type components FIG. 3 and a water control apparatus FIG. 4, 5. The water control apparatus which will be further discuss comprises a liquid buoyant float, a custom designed brass swivel type nozzle, a seal and various mounting/securing hardware. Now with reference to FIG. 3, the tubing material of choice is PVC, which has excellent mechanical properties to include resistance to chlorine, salts and UV radiation. Two measured different length hollow plastic tube members are bonded in a 90-degree manner by an elbow connection 2, with the longer member 1 of the set pointing vertically down and the shorter member pointing horizontally back. The result creates a hugging effect to the edge of a pool or spa where the outer deck and water retention wall meet as shown in FIG. 1. The member pointing back is bonded to a Tee connection 3 at its bottom. The top of the Tee connection 3 is then precisely reamed thru the openings as to tightly fit an inserted measured length of straight tube whereby it becomes entrapped, but free to rotate. Several forced small diameter indentations to the surface of the Tee's 3 outer diameter and close to tube opening is used to create an increased interference fit which results in a higher restrictive to motion fit for adjustability to mounting on different deck configurations FIG. 7a-d thus retaining wall parallelism and perpendicularity with the water level line. The said measured length includes the ability of the tube to extend out of both openings of the Tee connection 3. A dual combination of measured straight tube members and elbow are bonded to either extended ends of rotatable straight tube member to form a “U” shaped geometry FIG. 3. This geometric configuration creates stability for apparatus by preventing rotation around its horizontal axis when mounted and in contact with deck as shown in FIG. 1. The preference for the hollow plastic tube are thin walled as to maximize the volume of the hollow space created when joined. The empty volume is filled with weighted material and sealed at ends by bonding a tubing cap 5 on opening. This weighted design serves to restrain the device from movement when mounted at a pool edge and the apparatus is being struck by water movement. Further restriction of movement and enhanced gripping to the deck surface is achieve with a pliable grade and gummy PVC material 6 encircling the outer surface of straight members as referenced in FIG. 3. Again, for a robust design this material is clear, braided and highly UV and chemical resistant. The outer diameter of PVC material 6 slightly exceeds all other tube outer diameters as to provide the primary contact points. This description completes the deck side of the tubular structure, next we moved to the wall side and down into the water.

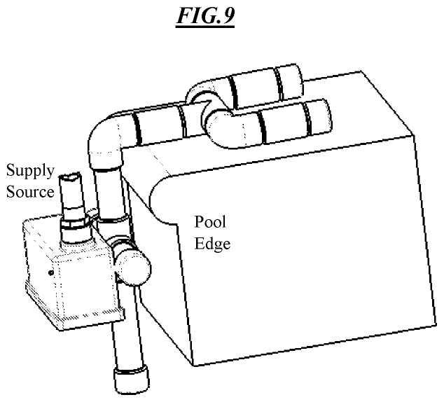

On the aforementioned down pointing member 1, a cross connection 4 is slipped on. Before this can be done, the cross connection 4 is precisely reamed through an inline set of openings to create a tight fit on outer diameter of the down pointing member 1. Several forced small diameter indentations, similar to the process done on the Tee connection 3 and for similar results, is used for adjustability to position the cross connection along the down pointing tube member 1 FIG. 8a-c. An end cap 5 is bonded to the bottom of the down pointing member and works as a hard stop for sliding cross connection. This hollow space can also be filled with weighted material if needed and then capped. In the remaining openings on the cross connection 3 a dual, measured length straight tube and bonded end cap 5 combination, is bonded into either open ends. The resulting structure serves as a support base for the flow control apparatus FIG. 4, 5 and they are secured together by corrosion resistant stainless steel hardware FIG. 2.

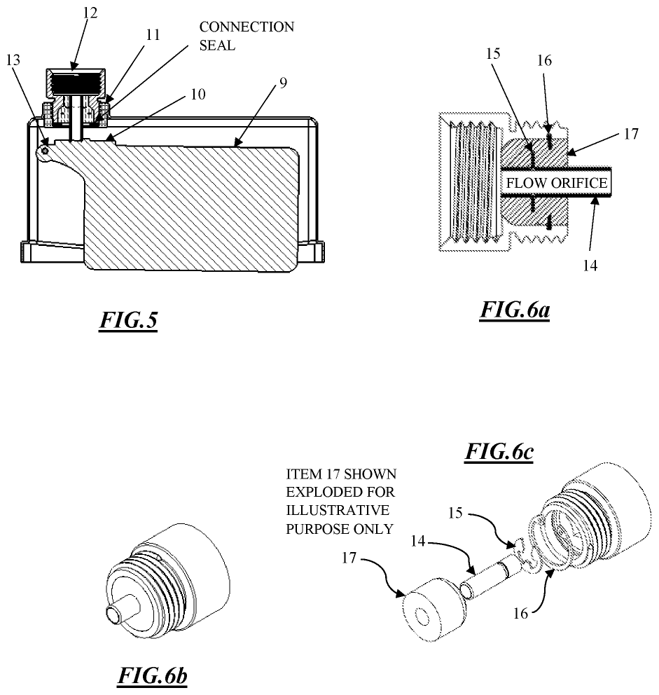

The flow control apparatus FIG. 4, 5 comprises of, a hollow vented box shaped plastic housing 7, which is molded from a UV radiation and chemical resistant material and has a faceless base FIG. 4. A float means 9 made of a high-density plastic material that is chemical resistant and possesses a non-stick surface property as to prevent crystallized residual build-up by flaking off. Said float 9 is secured inside the vented housing 7 by way of a pin 13 and through holes, and remain free to rotate about pin. A round flat seal 10 is secured at a centered thru hole to the float 9 by a chemical resistant plastic fastener and allowed to rotate about said pin. The ability to rotate the seal 10 creates new contact point for an off-centered fixed mounted nozzle. Said round flat seal 10 delivered best overall performance when made of Neoprene Rubber material with a 55±10 Durometer rating. A modified topside hollow internally threaded protrusion serves as a seating port 11 for a custom modified swivel hose nozzle and outlet combination FIG. 6a-c. The swivel nozzle 12 is made from a strong and highly corrosion resistant Naval Brass metal. The separation point of the inlet and outlet sections is of a captured swivel design with a ±5 degree of axial misalignment. This is incorporated as to relieve the stresses induced on the seating port 11 by connection to a stiff garden style hose or the likes. On the device outlet, better identified as the nozzle end, the entailing specifics of the custom design can be noted. A stainless steel tube 14 is secured inside the nozzle end with a high degree of concentricity and perpendicularity to its internal and end surface feature geometry. The securing material is a high-grade epoxy and sealant combination 17 that has established the highest tested resistance to the chlorinated and salinized water. Now referencing FIG. 6a, c. approximately half of the stainless steel tube 14 contains an abrasive surface treatment of a rough nature and a groove on the same area to accept a retaining clip 15. This process is done to promote high retention from enhance surface adherence and the anchoring ability of the retaining clip. A reverse process is carried out with retaining clip 16 and nozzle outlet wall. The protruding half of the aforementioned stainless steel tubing 14 has a highly polished exterior that is continued to a rounded end surface. Optimum operating levels are presented next. At complete flow shut-off, the tubing opening face 14 and flat of seal 10 must make flush contact with maximum angular tilt tolerance of ±1.5 degrees around the outlet opening central axis point and between the parallel contact planes. This design criteria has shown to remove the flow near cut-off phenomena of water hammering and water jetting which are both destructive to assemblies and material surfaces. The optimum flow orifice outlet FIG. 6a diameter is 0.116-0.125 inch at a working pressure of 1 to 200 psi. Stainless steel tubing 14 flow opening outer sharp edge is removed with a 0.005 to 0.010 radius as not to produce destructive memory markings on seal 10 contact surface. Finally, the use of a dielectric grease at the water inlet connection for dissimilar metal contact is the final addition towards the present invention superior performance and as a creative and innovative product for use in the pool and spa industry.

What is claimed is:

1. A water replenishing device comprising:
a) All plastic hollow tubing support structure having straight tubes, elbows, a Tee, a cross connection and sealing caps.
b) Several non-skid plastic wraps and weighted material.
c) A liquid flow control apparatus having a housing, a liquid buoyant float and a rubber type seal.
d) A custom engineered water supply connection that attaches to aforementioned liquid flow control apparatus.

2. A plastic as narrated in claim 1, which is economical, has excellent mechanical and fabricating properties, and is resistant to UV radiation, chlorine and salts.

3. A support structure as narrated in claim 1, that is designed per FIG. 3 and normally mounts per FIG. 1 as to provide maximum stability when in use.

4. A support structure as narrated in claim 1, in which the Tee and cross connections are mechanically modified by deforming to result in a tight and resistive fit hence when moved it will deliver a highly reliable and precise positional setting.

5. A non-skid wrap as narrated in claim 1, in which certain structural members are wrap with a non-skid softer durometer material having UV and corrosion resistant properties.

6. A non-skid wrap as narrated in claim 5, that when installed it presents itself as a first contact surface when mounted.

7. A water flow control apparatus as narrated in claim 1, which is in communication with the cross connection and can be positioned for precise water levels.

8. A water flow control apparatus as narrated in claim 1, which comprises a hollow vented open bottom, boxed shaped plastic housing containing a topside threaded port.

9. A housing as narrated in claim 8, is made of materials that is resistant to UV radiation, chlorine and salts.

10. A water flow control apparatus as narrated in claim 1, in which the housing encases a liquid buoyant float to provide a mechanical open and close action.

11. A liquid buoyant float as narrated in claim 10, which is made of high-density plastic material that is chemically corrosive resistant and possesses a non-stick surface property as to prevent crystallized residual build-up by flaking off.

12. A rubber type seal as narrated in claim 1, which is in communication with the liquid buoyant float and made of Neoprene having a nominal durometer of 50-60.

13. A Neoprene seal as narrated in claim 9, which is flat and round and center mounted as to rotate around its center and present a new sealing surface in each 90-degree quadrant.

14. A custom-engineered connection as narrated in claim 1, that is in communication with housing at a threaded inlet port and swivels.

15. A custom-engineered connection as narrated in claim 1, which is made of Naval Brass metal hence called a swivel nozzle.

16. A custom-engineered connection as narrated in claim 1, which uses a superior corrosion resistant grade stainless steel tube to offer as a flow orifice.

17. A custom-engineered connection as narrated in claim 1, which uses superior bonding agent to secure flow orifice tubing to swivel nozzle outlet.

18. A custom-engineered connection as narrated in claim 1, which uses surface treatment, feature geometry and secured attachment to provide enhanced hold from the gripping and anchoring action they produce.

19. A custom-engineered connection as narrated in claim 1, that its flow orifice tubing contains specified rounded and polished ends

20. A custom-engineered connection as narrated in claim 19, is implemented to prevent the destructive actions of water hammering and water jetting.
